(19) United States
(12) Patent Application Publication
(10) Pub. No.: US 2016/0062845 A1
(43) Pub. Date: Mar. 3, 2016

(54) Populating Image Metadata By Cross-Referencing Other Images

(71) Applicant: Vincent Mo, Sunnyvale, CA (US)

(72) Inventor: Vincent Mo, Sunnyvale, CA (US)

(73) Assignee: GOOGLE INC., Mountain View, CA (US)

(21) Appl. No.: 13/346,316

(22) Filed: Jan. 9, 2012

(51) Int. Cl. G06F 17/30

(52) U.S. Cl. CPC G06F 11/1464; G06F 17/30268; G06F 17/30867; G06F 17/30371; G06F 2201/80

(57) ABSTRACT

Methods, systems, and apparatus, including computer programs encoded on a computer storage medium, for accessing first image metadata corresponding to a first image, the first image metadata including a plurality of first image data fields, determining that at least one data field of the plurality of first image data fields is a null data field, in response to determining that at least one data field is a null data field, accessing second image metadata corresponding to a second image, the second image metadata including a plurality of second image data fields, determining that the second image corresponds to the first image, and cross-referencing the at least one data field with data from a corresponding data field of the plurality of second image data fields.

### TECHNICAL FIELD

This specification generally relates to populating image metadata by cross-referencing other images.

### BACKGROUND

People take photographs (photos) to document events and to keep memories. People often share the photos with friends and family. In recent years, digital photography has become more mainstream. Using digital photography, a photographer can capture a photograph and store the photograph as a digital image having a digital image file. The digital image file can be stored to computer-readable memory, can be copied and can be electronically distributed. The Internet has made the sharing of photos much easier. People can email images to friends, or post images on websites for others to view. Social networking websites are also used to share images with friends and acquaintances.

### SUMMARY

In general, innovative aspects of the subject matter described in this disclosure may be embodied in methods that include the actions of accessing first image metadata corresponding to a first image, the first image metadata including a plurality of first image data fields, determining that at least one data field of the plurality of first image data fields is a null data field, the null data field including a data field that includes at least one of data that is incomplete, corrupted, non-compliant and non-existent, in response to determining that at least one data field is a null data field, accessing image metadata of a plurality of images and comparing the first image metadata to the image metadata, based on the comparing, determining that the first image metadata corresponds to second image metadata of a second image, the second image being included in the plurality of images, the second image metadata being provided in a plurality of second image data fields, and cross-referencing the at least one data field with data from a corresponding data field of the plurality of second image data fields. Other implementations of these aspects include corresponding systems, apparatus, and computer programs, configured to perform the actions of the methods, encoded on computer storage devices.

Innovative aspects of the subject matter described in this disclosure may also be embodied in methods that include the actions of accessing first image metadata corresponding to a first image, the first image metadata including a plurality of first image data fields, determining that at least one data field of the plurality of first image data fields is a null data field, in response to determining that at least one data field is a null data field, accessing second image metadata corresponding to a second image, the second image metadata including a plurality of second image data fields, determining that the second image corresponds to the first image, and cross-referencing the at least one data field with data from a corresponding data field of the plurality of second image data fields. Other implementations of these aspects include corresponding systems, apparatus, and computer programs, configured to perform the actions of the methods, encoded on computer storage devices.

These and other implementations may each optionally include one or more of the following features: accessing first image metadata includes receiving a first digital image file from a user, the first digital image file including the first image metadata; accessing first image metadata includes: accessing user data associated with a user participating in a social networking service, and searching the user data for a first digital image file, the first digital image file including the first image metadata; accessing second image metadata includes searching a data store, the data store including a plurality of digital image files; determining that the second image corresponds to the first image includes determining that data in one or more data fields of the first image metadata corresponds to data in one or more data fields of the second image metadata; determining that data in one or more data fields of the first image metadata corresponds to data in one or more data fields of the second image metadata includes determining that a time stamp of the first image metadata is within a predetermined time threshold of a time stamp of the second image metadata; determining that data in one or more data fields of the first image metadata corresponds to data in one or more data fields of the second image metadata includes determining that a geo-code of the first image metadata is within a predetermined distance threshold as a geo-code of the second image metadata; determining that the second image corresponds to the first image includes determining that the first image metadata and the second image metadata include a plurality of coincident data field entries; the plurality of coincident data field entries includes time stamp entries and geo-code entries; the plurality of data field entries includes time stamp entries and tag entries; the at least one null data field includes a data field that includes at least one of data that is incomplete, corrupted, non-compliant and non-existent; and cross-referencing includes at least one of populating and replacing data of the at least one data field with data from the corresponding data field.

Particular implementations of the subject matter described in this specification may be used to realize the following, example advantage: image metadata appended to digital image files can be automatically updated or completed by cross-referencing other related digital images that are accessible to a computing system.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 depicts an example system that can be used in implementations of the present disclosure.

FIG. 2 depicts an example environment for image cross-referencing.

FIG. 3 depicts an example architecture of the first digital image file of FIG. 2.

FIG. 4 illustrates a cross-referencing operation between the first and second digital image files of FIG. 2.

FIG. 5 is a flowchart illustrating an example process for cross-referencing image metadata.

Like reference numbers represent corresponding parts throughout.

### DETAILED DESCRIPTION

The present disclosure is directed to systems and techniques for populating image metadata of one digital image file by cross-referencing the digital image file with other digital image files. In some examples, image metadata associated with a first image is accessed. The image metadata can include information appended to a digital image file that describes one or more aspects of the digital image. In some examples, the first image metadata can be organized in a plurality of data fields. In some implementations, it can be determined that at least one image data field included in the first image metadata is a null data field. In response, image metadata corresponding to a second image can be accessed. For example, it can be determined that the second image is corresponds to the first image. Null data fields of the first image metadata can be populated and/or replaced with data from the second image metadata.

Image metadata provides information that supplements the primary content of digital image files. For example, image metadata can include information describing how large the image is, the color depth and resolution of the image, where the image was taken (e.g., geo-location data), the owner of the image, and/or the device that generated the image. Other types of image metadata can include, for example, titles or keywords describing the image and/or tags of people or items depicted in the digital image. This information can be used to organize and search large libraries of digital images. In some instances, however, a data field of the image metadata can be considered a null data field. As used herein, a null data field can include a data field in which data is incomplete, corrupted, non-compliant, or non-existent. For example, information in a data field can be left incomplete when the device generating the image is not equipped to provide the information for the particular data field. As another example, data can be stripped from a data field or corrupted during file uploads and/or transfers. In some examples, non-compliant data can include data that does not comply with a format expected for the particular data field.

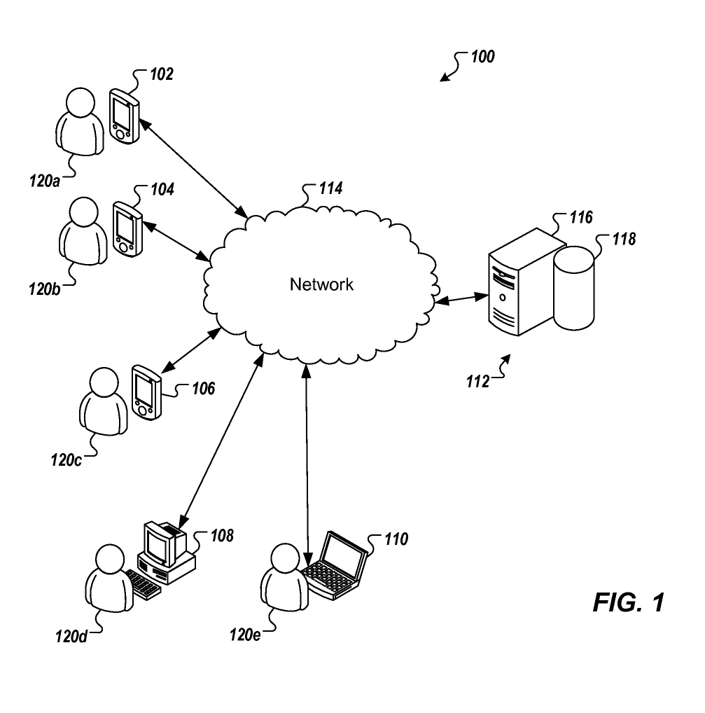

FIG. 1 depicts an example system 100 that can be used in implementations of the present disclosure. The example system 100 includes a plurality of client computing devices 102-110, each of the computing devices being associated with one of users 120a-120e. The system 100 also includes a network 114, and a computing system 112. The computing devices 102-110 and the computing system 112 can communicate with each other through the network 114. The computing system 112 can include one or more computing devices 116 (e.g., one or more servers) and one or more computer-readable storage devices 118 (e.g., one or more databases).

Each of computing devices 102-110 can represent various forms of processing devices. Example processing devices can include a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. The computing devices 102-110 and 116 can be provided access to and/or receive application software executed and/or stored on any of the other computing systems 102-110 and 116. The computing device 116 can represent various forms of servers including, but not limited to a web server, an application server, a proxy server, a network server, or a server farm. In some examples, the computing device 116 performs functions of a social network server.

In some implementations, the computing devices can communicate wirelessly through a communication interface (not shown), which may include digital signal processing circuitry where necessary. The communication interface can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some implementations, the system 100 can be a distributed client/server system that spans one or more networks such as the network 114. The network 114 can be a large computer network, such as a local area network (LAN), wide area network (WAN), the Internet, a cellular network, or a combination thereof connecting any number of mobile clients, fixed clients, and servers. In some implementations, each client (e.g., computing devices 102-110) can communicate with servers (e.g., computing device 116) via a virtual private network (VPN), Secure Shell (SSH) tunnel, or other secure network connection. In some implementations, the network 114 can further include a corporate network (e.g., intranet) and one or more wireless access points.

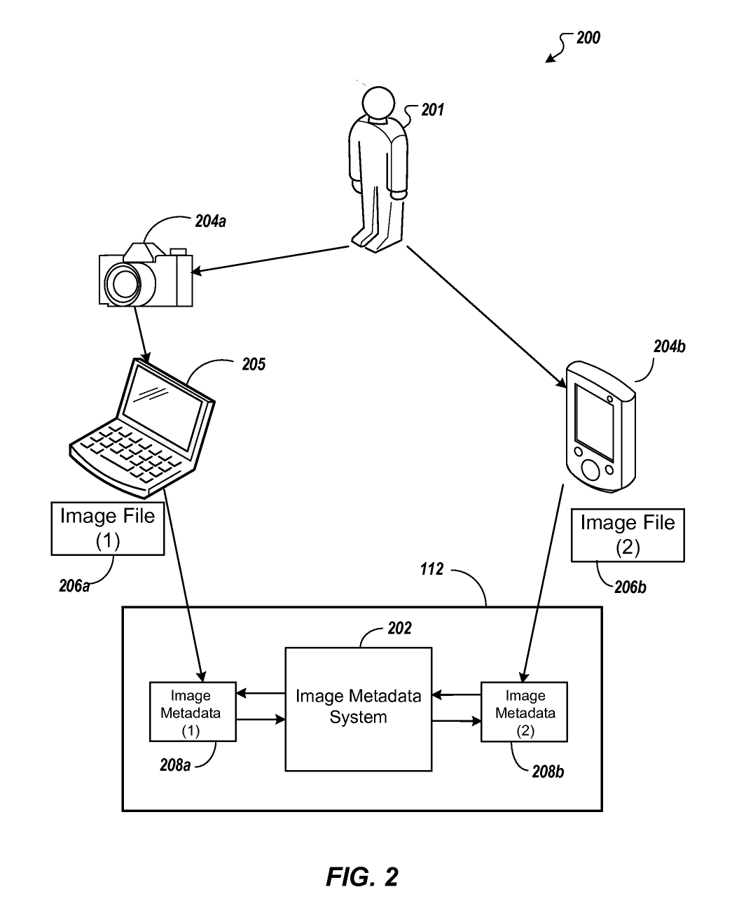

FIG. 2 depicts an example environment 200 for image cross-referencing. The example environment 200 includes an image metadata system 202. The image metadata system 202 can be implemented, for example, using one or more computing systems (e.g., the computing system 112 of FIG. 1). By way of a non-limiting example, a user 201 takes a first photo with a first device 204a (e.g., a hand-held digital camera) and a second photo with a second device 204b (e.g., a smart phone). The user 201 uploads both a first digital image file 206a corresponding to the first photo and a second digital image file 206b corresponding to the second photo to the computing system 112 (e.g., by communicating with the computing system 112 through the network 114 of FIG. 1). For example, as shown, the first digital image file 206a can be transferred from the digital camera 204a to a suitable computing device 205. The computing device 205 can be used to upload the first digital image file 206a to the computing system 112. In this example, the second digital image can be uploaded to the computing system 112 directly from the smart phone 204b over a network.

The first and second digital image files 206a and 206b can include respective image metadata 208a and 208b. As noted above, the image metadata can include information that describes one or more aspects of the respective images (e.g., information describing how large the image is, the color depth and resolution of the image, where the image was taken, the owner of the image, the device that generated the image, titles or keywords describing the image, and/or face tags). In some examples, such information can be organized according to one or more prescribed metadata standards or schemas having a plurality of predetermined data fields (as described in detail below). In this example, the image metadata system 202 can access the first image metadata 208a and recognize that a data field of the image metadata is a null data field. For instance, the first image metadata 208a might not include location information (e.g., geo-location data indicating where the image was generated). Consequently, a location data field of the first image metadata 208a can be determined to be a null data field. The image metadata system 202 can accesses the second image metadata 208b and complete the first metadata 208a by cross-referencing with the second metadata 208b.

While the non-limiting example described above accurately describes one or more aspects of the present disclosure, it should be noted that other implementations are also envisioned. For example, the image files 206a, 206b can both come from the same user (e.g., the user 201), or can come from respective users (e.g., the user 201 and another user). The devices 204a and 204b, respectively depicted as a digital camera and a smart phone, can also be provided in the form of other appropriate devices (e.g., web cams and the like). Additionally, the image metadata system 202 can be implemented on an individual computing device. For example, a user can upload digital image files to a personal computer implementing the image metadata system 202.

In some implementations, the image metadata system 202 can be provided in the context of a social networking service. For example, users can upload digital image files to a webpage (e.g., a profile page) hosted by the social networking service. A computing system associated with the social networking service (e.g., a social networking server) can access the uploaded digital image files to determine whether any data fields in the appended metadata files are empty. For example, the social networking server can check the webpage for recently uploaded image files randomly or at predetermined time intervals. Upon recognition of metadata null data field, the social networking server can initiate a search for other related image files with metadata for cross-referencing. In some implementations, the search can be exhaustive. For example, the social networking server can access image files included in the social networking corpus to identify appropriate image files for cross-referencing. In some implementations, the search can be limited. For example, the social networking server can adhere to a prescribed search radius by only accessing image files of users that are linked to the user's profile page (e.g., profile pages assigned to members of the social network that are socially related to the user). Other suitable search routines and methods can also be used. Generally, members of the social networking service can be provided with an opportunity to opt in/out of programs or features that may collect personal information (e.g., information relating to the user's social graph and/or metadata appended to uploaded personal photos). In addition, certain data may be anonymized in one or more ways before it is stored or used, so that personally identifiable information is removed.

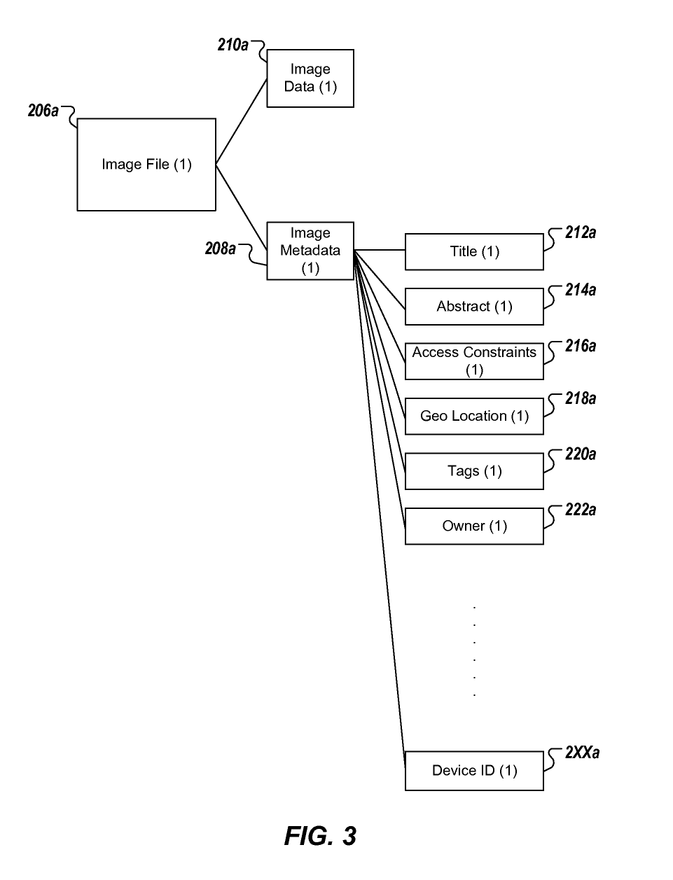

FIG. 3 depicts an example architecture of the first digital image file 206a of FIG. 2. As shown, the first digital image file 206a can include first image data 210 and the first image metadata 208a. The first image data 210a can include information for rendering the captured image (i.e., the content of the image). For example, the first image data 210a can include data (e.g., pixel and/or vector data) for providing a numeric representation of the image. This data can be organized, stored, or compressed according to an appropriate 2-dimensional or 3-dimensional graphic file format (e.g., PNG, JPEG, BMP, TIFF, RAW, and GIF).

The first image metadata 208a includes information that describes one or more aspects of the first image file 206a. For instance, in this example, the first image metadata includes data fields 212a-2XXa. As shown, data fields 212a-2XXa include fields for a Title, Date/Time Stamp, Access Constraints, Geo Location (e.g., Geo-Code), Tags, Owner, and Device Identification (ID), respectively. The Title data field 212a can include a user-provided title for the image or appropriate keywords for identifying the corresponding image. The Date/Time Stamp data field 214a can include information describing when the corresponding image was generated. The Access Constraints data field 216a can include information relating to privacy restrictions and/or viewing rights pertaining to the corresponding image. The Geo Location data field 218a can include information describing where the corresponding image was generated. The Tags data field 220a can include information identifying particular entities or objects (e.g., an identifiable building, statue, or monument) that are visible in the corresponding photo. The Owner data field 222a can include information identifying the owner or creator of the digital image file. The Device ID data field 2XXa can include information identifying the device used to generate the digital image file. Other suitable data fields, for example, Ratings, Copyright Descriptions, Notes, and/or Image Orientation data fields can also be included.

In some implementations, data fields 212a-2XXa can be provided according to one or more metadata standards, for example, Dublin Core, Exif, XMP, Picture Licensing Universal System (PLUS), IPTC Core & Extension, and/or IPTC-IIM. In some implementations, the first image metadata can include data fields from a plurality of metadata schemas. For example, the Geo Location data field 218a can be provided as part of the Exif schema, and the Title data field 212a can be provided as part of the XMP schema.

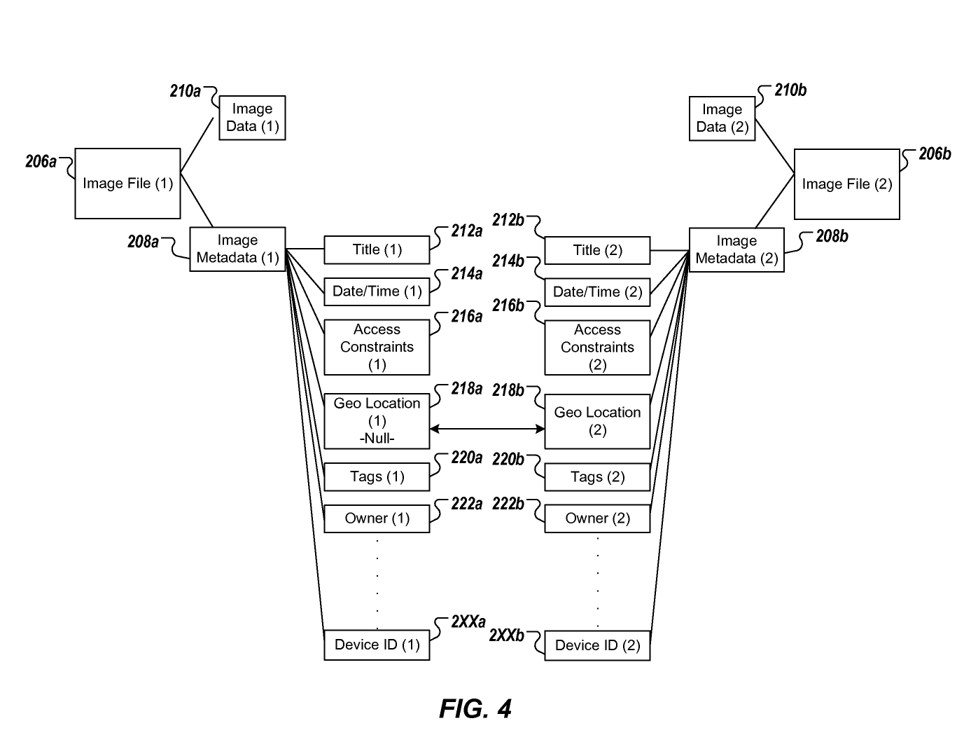

FIG. 4 illustrates a cross-referencing operation between the first and second digital image files 206a, 206b of FIG. 2. The cross-referencing operation can be executed by an appropriate system (e.g., image metadata system 202). In some implementations, the cross-referencing operation can include determining that the first and second digital image files 206a, 206b correspond to one another, and cross-referencing null data fields from one of the first and second image metadata 208a, 208b with data from the other of the first and second image metadata 208a, 208b. In some examples, cross-referencing can include populating a null data field of one of the first and second image metadata 208a, 208b with data from the other of the first and second image metadata 208a, 208b. In some examples, cross-referencing can include replacing data of a null data field of one of the first and second image metadata 208a, 208b with data from the other of the first and second image metadata 208a, 208b.

In some implementations, the image metadata system 202 can be configured to determine that respective digital image files correspond to one another by detecting particular coincident components of image metadata between the digital image files (or particular combinations of coincident image metadata components). For example, the image metadata system 202 can recognize that images corresponding to respective digital image files were taken at approximately the same time and place by comparing the data provided in the Date/Time Stamp data fields and the Geo Location data fields. In some examples, the image metadata system 202 can reference a threshold amount of time to determine whether the corresponding images are deemed to have been taken at approximately the same time. For example, the image metadata system 202 can determine that images taken within the threshold amount of time (e.g., X minutes, where X can be any positive number) of each other are close enough in time that the images might be related to one another. For example, a difference between a first time/date stamp associated with a first image and a second time/date stamp associated with a second image can be determined. If the difference is less than or equal to the threshold amount of time, the first and second images can be deemed to have been taken at approximately the same time. If the difference is greater than the threshold amount of time, the first and second images can be deemed to have not been taken at approximately the same time. Similarly, in some examples, the image metadata system 202 can reference a threshold distance to determine whether the corresponding images are deemed to have been taken at approximately the same location.

In the example illustrated by FIG. 4, the image metadata system 202 can determine that the first and second digital image files 206a, 206b are related to one another by comparing data provided in the Date/Time Stamp data fields 214a, 214b and the Tags data fields 220a, 220b. More specifically, the image metadata system 202 can recognize that the corresponding images of the first and second digital image files 206a, 206b were taken at approximately the same time and include one or more identical entities tagged therein. Based on this recognition, the image metadata system 202 can infer that the images were taken at the same location. In the depicted example, the Geo Location data field 218a of the first image metadata 208a can be determined to be a null data field. In some examples, the Geo Location data field 218a can be absent of data or include data that is incomplete, corrupted or non-compliant. Consequently, the image metadata system 202 can populate or replace the null Geo Location data field 218a of the first image metadata 208a with information from the Geo Location data field 218b of the second image metadata 208b.

While the above non-limiting example describes one or more aspects of the present disclosure, further implementations are also envisioned. For example, other types of data fields can be compared to determine whether respective digital image files correspond to one another. For example, the image metadata system 202 can be configured to infer that digital image files with the same Device ID identified in metadata are deemed to have the same owner. The image metadata system 202 can also be configured to infer that the corresponding images of digital image files with similar titles are deemed to have been taken on the same date (for example, a title of a first image file can be provided as “Timmy's Birthday Party 08′—Timmy and Grandma” and a second image file can be entitled “Timmy's Birthday Party 08′—Timmy and Dad”). Other suitable metadata data fields and/or combinations of such data fields can also be used to determine whether digital image files correspond to one another.

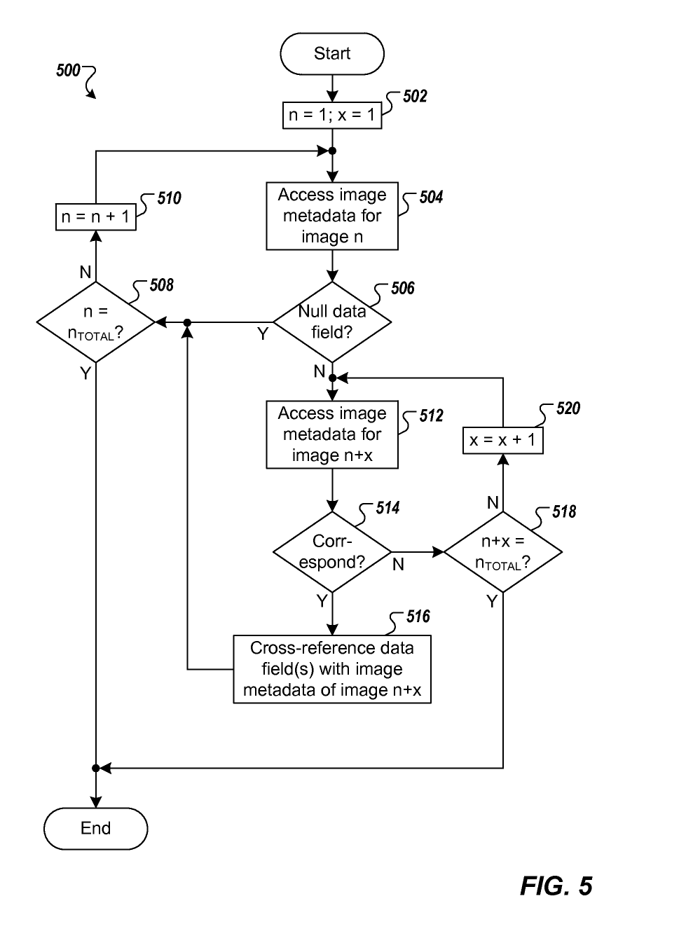

FIG. 5 is a flowchart illustrating an example process 500 for cross-referencing image metadata. The process 500 can be provided in one or more computer programs executed using one or more computing devices (e.g., the server device 112 of FIG. 1). Counters n and x are each set equal to 1 (502). Image metadata for image n is accessed (504). It is determined whether one or more data fields of the image metadata for image n include a null data field (506). If it is determined that one or more data fields of the image metadata for image n do not include a null data field, it is determined whether n is equal to n_{TOTAL} (508). n_{TOTAL} can be the total number of image files in a set of image files being processed using the process 500. If n is equal to n_{TOTAL}, the process 500 ends. If n is not equal to n_{TOTAL}, the counter n is incremented (510) and the process loops back.

If it is determined that one or more data fields of the image metadata for image n include a null data field, image metadata for image n+x is accessed (512). It is determined whether image n and image n+x correspond to one another (514). In some examples, metadata of the images can be compared and, if there is sufficient overlap in the metadata, the images can be determined to correspond to one another. If image n and image n+x correspond to one another, one or more null data fields of image n are cross-referenced with metadata from corresponding image data fields of image n+x (516), and it is determined whether n is equal to n_{TOTAL} (508). If image n and image n+x do not correspond to one another, it is determined whether n+x is equal to n_{TOTAL} (518). If n+x is equal to n_{TOTAL}, the process 500 ends. If n+x is not equal to n_{TOTAL}, the counter x is incremented (520) and the process 500 loops back to access image metadata for image n+x (512).

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the present disclosure can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclose can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other.

While this disclosure includes some specifics, these should not be construed as limitations on the scope of the disclosure or of what may be claimed, but rather as descriptions of features of example implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method executed using one or more processors, the method comprising:
accessing first image metadata corresponding to a first image, the first image metadata comprising a plurality of first image data fields;
determining that one or more specific data fields of the plurality of first image data fields is a null data field, the null data field comprising a data field that includes at least one of data that is corrupted, non-compliant and non-existent;
in response to determining that one or more specific data fields is a null data field, initiating a search for image metadata of a plurality of images and comparing the first image metadata to the image metadata of the plurality of images;
based on the comparing, determining that the first image metadata corresponds to second image metadata of a second image, the second image being included in the plurality of images, the second image metadata being provided in a plurality of second image data fields; and
completing only the one or more specific data fields by cross-referencing the one or more specific data fields with data from a corresponding data field of the plurality of second image data fields, wherein cross-referencing comprises at least one of populating and replacing data of the one or more specific data fields with data from the corresponding data field of the plurality of second image data fields.

2. A computer-implemented method executed using one or more processors, the method comprising:
accessing first image metadata corresponding to a first image, the first image metadata comprising a plurality of first image data fields;
determining that one or more specific data fields of the plurality of first image data fields is a null data field, the null data field comprising a data field that includes at least one of data that is corrupted, non-compliant and non-existent;
in response to determining that one or more specific data fields is a null data field, initiating a search for second image metadata corresponding to a second image, the second image metadata comprising a plurality of second image data fields;
determining that the second image corresponds to the first image; and
completing only the one or more specific data fields by cross-referencing the one or more specific data fields with data from a corresponding data field of the plurality of second image data fields, wherein cross-referencing comprises at least one of populating and replacing data of the one or more specific data fields with data from the corresponding data field of the plurality of second image data fields.

3. The method of claim 2, wherein accessing first image metadata comprises receiving a first digital image file from a user, the first digital image file comprising the first image metadata.

4. The method of claim 2, wherein accessing first image metadata comprises:
accessing user data associated with a user participating in a social networking service; and
searching the user data for a first digital image file, the first digital image file including the first image metadata.

5. The method of claim 2, wherein accessing second image metadata comprises searching a data store, the data store comprising a plurality of digital image files.

6. The method of claim 2, wherein determining that the second image corresponds to the first image comprises determining that data in one or more data fields of the first image metadata corresponds to data in one or more data fields of the second image metadata.

7. The method of claim 6, wherein determining that data in one or more data fields of the first image metadata corresponds to data in one or more data fields of the second image metadata comprises determining that a time stamp of the first image metadata is within a predetermined time threshold of a time stamp of the second image metadata.

8. The method of claim 6, wherein determining that data in one or more data fields of the first image metadata corresponds to data in one or more data fields of the second image metadata comprises determining that a geo-code of the first image metadata is within a predetermined distance threshold as a geo-code of the second image metadata.

9. The method of claim 2, wherein determining that the second image corresponds to the first image comprises determining that the first image metadata and the second image metadata comprise a plurality of coincident data field entries.

10. The method of claim 9, wherein the plurality of coincident data field entries comprises time stamp entries and geo-code entries.

11. The method of claim 9, wherein the plurality of data field entries comprises time stamp entries and tag entries.

12. (canceled)

13. (canceled)

14. A system comprising:
a computer having one or more processors configured to interact with a non-transitory computer storage device in order to perform operations comprising:
accessing first image metadata corresponding to a first image, the first image metadata comprising a plurality of first image data fields;
determining that one or more specific data fields of the plurality of first image data fields is a null data field, the null data field comprising a data field that includes at least one of data that is corrupted, non-compliant and non-existent;
in response to determining that one or more specific data fields is a null data field, initiating a search for second image metadata corresponding to a second image, the second image metadata comprising a plurality of second image data fields;
determining that the second image corresponds to the first image; and
completing only the one or more specific data fields by cross-referencing the one or more specific data fields with data from a corresponding data field of the plurality of second image data fields, wherein cross-referencing comprises at least one of populating and replacing data of the one or more specific data fields with data from the corresponding data field of the plurality of second image data Amendment in response to office action fields.

15. The system of claim 14, wherein accessing first image metadata comprises receiving a first digital image file from a user, the first digital image file comprising the first image metadata.

16. The system of claim 14, wherein accessing first image metadata comprises:
accessing user data associated with a user participating in a social networking service; and
searching the user data for a first digital image file, the first digital image file including the first image metadata.

17. The system of claim 14, wherein accessing second image metadata comprises searching a data store, the data store comprising a plurality of digital image files.

18. The system of claim 14, wherein determining that the second image corresponds to the first image comprises determining that data in one or more data fields of the first image metadata corresponds to data in one or more data fields of the second image metadata.

19. The system of claim 18, wherein determining that data in one or more data fields of the first image metadata corresponds to data in one or more data fields of the second image metadata comprises determining that a time stamp of the first image metadata is within a predetermined time threshold of a time stamp of the second image metadata.

20. The system of claim 18, wherein determining that data in one or more data fields of the first image metadata corresponds to data in one or more data fields of the second image metadata comprises determining that a geo-code of the first image metadata is within a predetermined distance threshold as a geo-code of the second image metadata.

21. The system of claim 14, wherein determining that the second image corresponds to the first image comprises determining that the first image metadata and the second image metadata comprise a plurality of coincident data field entries.
